(19) United States
(12) Patent Application Publication
(10) Pub. No.: US 2009/0149561 A1
(43) Pub. Date: Jun. 11, 2009

(54) EXTRUDED POLYMER FOAMS CONTAINING BROMINATED 2-OXO-1,3,2-DIOXAPHOSPHORINANE COMPOUNDS AS FLAME RETARDANT ADDITIVES

(76) Inventors: Anteneh Z. Worku, Pearland, TX (US); William G. Stobby, Midland, MI (US); Sheila M. Tinetti, Vernon Hills, IL (US); Inken Beulich, Buehl Bw (DE); David R. Wilson, Midland, MI (US); Duane R. Romer, Midland, MI (US); James P. Godschalx, Midland, MI (US); Nelson G. Rondan, Missouri City, TX (US); William J. Kruper, JR., Sanford, MI (US); Ted A. Morgan, Midland, MI (US)

Correspondence Address: The Dow Chemical Company;Gary C. Cohn, P. O. Box 313, Huntingdon Valley, PA, 19006, US

(21) Appl. No.: 12/331,856

(22) Filed: Dec. 10, 2008

Related U.S. Application Data
(60) Provisional application No. 61/007,187, filed on Dec. 11, 2007.

(51) Int. Cl. C08J 9/35

(52) U.S. Cl. 521/79

(57) ABSTRACT

Extruded polymer foams are prepared using 5,5-bis(bromomethyl)-2-oxo-1,3,2-dioxaphosphorinane or brominated 2-oxo-1,3,2-dioxaphosphorinane compounds. The brominated FR additives unexpectedly are stable at the extrusion temperatures, and provide excellent flame retardancy to the foams.

This application claims priority from U.S. Provisional Patent Application No. 61/007,187, filed 11 Dec. 2007.

The present invention relates to extruded polymer foams, such as expanded styrenic polymers and copolymers, which contain flame retardant agents based on brominated 2-oxo-1,3,2-dioxaphosphorinane compounds.

Flame retardant (FR) additives are commonly added to extruded polymer foam products that are used in construction and automotive applications. The presence of the FR additive allows the foam to pass standard fire tests, as are required in various jurisdictions. Various low molecular weight (<˜1000 g/mol) brominated compounds are used as FR additives in these foam products. Many of these, such as hexabromocyclododecane, are under regulatory and public pressure that may lead to restrictions on their use, and so there is an incentive to find a replacement for them.

An alternative FR additive for extruded polymer foams should be capable of allowing the foam to pass standard fire tests, when incorporated into the foam at reasonably low levels. Because extruded foams are processed at elevated temperatures, it is important that the FR additive be thermally stable at the temperature conditions used in the extrusion process. For some foams, such as polystyrene and styrene copolymer foams, these temperatures are often 180° C. or higher. Several problems are encountered if the FR additive decomposes during the extrusion process. These include loss of FR agent and therefore loss of FR properties, and the generation of decomposition products (such as HBr) that are often corrosive and therefore potentially dangerous to humans and harmful to operating equipment. The FR agent should not cause a significant loss of desirable physical properties in the polymer. It is preferable that the FR additive has low toxicity and is not highly bioavailable.

Various phosphorus compounds have been used as FR additives in various types of polymers. These include organic phosphates, phosphonates and phosphoramides, some of which are described in U.S. Pat. Nos. 4,007,236, 4,070,336, 4,086,205 and 4,098,759. These compounds have been suggested for use mainly in noncellular polymers, although some of then have been suggested as being useful in polyurethane foams and in expandable polystyrene bead foam. At least some of these have been restricted for use at temperataures of 170° C. or below because of a lack of thermal stability at higher temperatures. These compounds tend to provide moderate ignition resistance, and are generally not as robust as hexabromocyclododecane or other brominated FR additives.

The present invention is in one aspect a process comprising forming a pressurized mixture of (A) a molten styrene homopolymer or copolymer, a flame retarding amount of (B) or (B1) or a mixture of (B) and (B1), wherein (B) is at least one 5,5-bis(bromomethyl)-2-oxo-1,3,2-dioxaphosphorinane compound and (B1) is at least one alkane or cycloalkane that is substituted with (1) at least one 2-oxo-1,3,2-dioxaphosphorinane group and (2) at least one bromine atom, and (C) a blowing agent, and extruding the mixture into a region of reduced pressure such that the mixture expands and cools to form an expanded polymer containing component (B), (B1) or both (B) and (B1).

The invention is also an extruded styrene homopolymer or copolymer foam, having a density of from 1 to about 30 lb/ft³ (16-480 kg/m³) and containing at least one 5,5-bis(bromomethyl)-2-oxo-1,3,2-dioxaphosphorinane, at least one alkane or cycloalkane that is substituted with (1) at least one 2-oxo-1,3,2-dioxaphosphorinane group and (2) at least one bromine atom, or a mixture thereof.

Extruded foam made in accordance with the invention exhibits excellent FR properties, as indicated by various standard tests. Even though the B or B1 compounds usually experience temperatures in excess of 180° C. during the extrusion process, it has been found that little or no thermal degradation of the B or B1 compounds occurs as the foam formulation is processed and extruded. Therefore, the FR additive is not consumed or degraded during the foam manufacturing process.

The B and B1 compounds have been found to be stable under the extrusion conditions, even when water and/or carbon dioxide are present. Water and carbon dioxide are capable of engaging in hydrolysis reactions with ester compounds and compounds of phosphoric acid. Therefore the stability of the B and B1 compounds, in the presence of water and carbon dioxide and under elevated temperature conditions, is surprising.

Because the B and B1 compounds are stable under the extrusion conditions, they do not produce significant amounts of decomposition products that can attack the styrene homopolymer or copolymer and cause a reduction in molecular weight.

In certain aspects of the invention, extruded styrene homopolymer or copolymer foams are made containing a 5,5-bis(bromomethyl)-2-oxo-1,3,2-dioxaphosphorinane compound (component B). For purposes of this invention, a 5,5-bis(bromomethyl)-2-oxo-1,3,2-dioxaphosphorinane compound is a compound that contains at least one 5,5-bis(bromomethyl)-2-oxo-1,3,2-dioxaphosphorinyl group having the structure I:

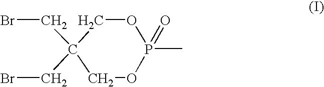

Suitable component B materials include those represented by the structure II:

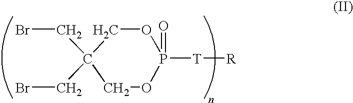

wherein T is a covalent bond, oxygen, sulfur or —NR¹—, wherein R¹ is hydrogen, alkyl or inertly substituted alkyl, n is at least 1, and R is an unsubstituted or inertly substituted organic group that is bonded to the -T- linkage through a carbon atom on the R group. n may be any positive number, is preferably from 1 to 50 and more preferably from 1 to 4.

When T is a covalent bond, a carbon atom of the R group is bonded directly to the phosphorus atom of the 5,5-bis(bromomethyl)-2-oxo-1,3,2-dioxaphosphorinyl group. When T is oxygen, sulfur or —NR¹—, a carbon atom of the R group is bonded directly to the oxygen, sulfur or nitrogen atom of the T group, as the case may be.

The R group in structure II may be aliphatic, aromatic, alicyclic, or a combination of those types of organic groups. The R group may be a hydrocarbyl group, in which case it contains only carbon and hydrogen atoms. An R group that is a hydrocarbyl group may be, for example, a straight or branched chain alkane group, a straight or branched chain alkene group, a cycloalkane group, an alkyl-substituted cycloalkane group, a benzene ring, a fused aromatic ring structure, an alkyl-substituted benzene or an alkyl-substituted aromatic ring structure, and the like, in each case having removed a number of hydrogen atoms equal to n. Unsubstituted alkane groups suitably contain from one to 50, preferably from 2 to 10 and especially from 3-6 carbon atoms.

Alternatively, the R group in structure II may be an inertly substituted organic group. In this application, an “inert” substituent is one that does not undesirably interfere with the flame retardant properties of the additive. A compound or group containing an inert substituent is said to be “inertly substituted”. The inert substituent may be, for example, an oxygen-containing group such as an ether, ester, carbonyl, hydroxyl, carbonate, or carboxylic acid, and the like. The inert substituent may be a nitrogen-containing group such as a primary, secondary or tertiary amine group, an imine group, a cyano group, an amide group or a nitro group. The inert substituent may contain other hetero atoms such as sulfur, phosphorus, silicon (such as silane or siloxane groups), halogen (such as chlorine or bromine) and the like. In certain preferred embodiments, the R group is substituted with one or more bromine atoms. It is preferred that the R group is not bromine-substituted at the carbon atom(s) which are bonded directly to a -T- linkage in structure I.

Other suitable component B materials include those represented by the structure III:

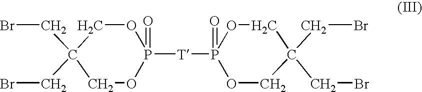

wherein T′ is oxygen, sulfur, or —NR¹—, wherein R¹ is hydrogen, alkyl or inertly substituted alkyl.

Specific compounds that are useful as component B include those having the following structures IV-X:

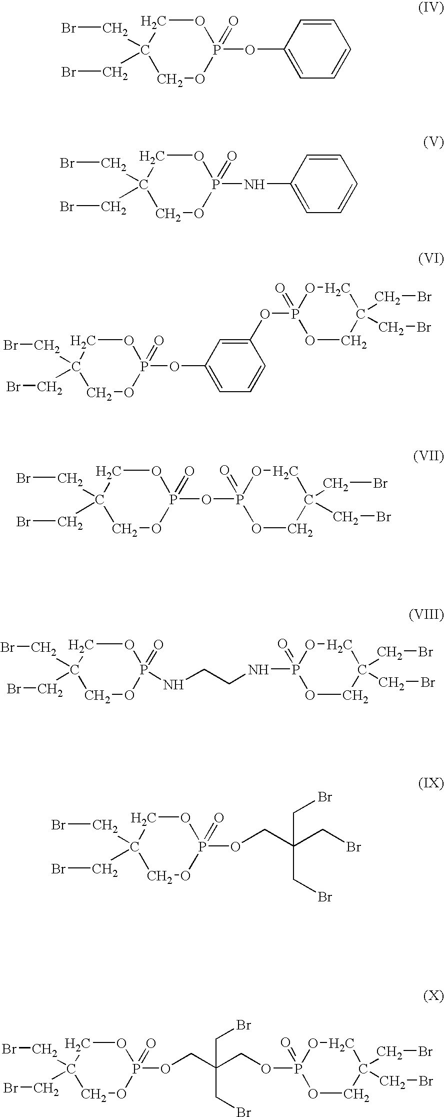

In other aspects of the invention, the extruded foam is made containing a component B1 compound. The component B1 compound is an alkane or cycloalkane that is substituted with (1) at least one 2-oxo-1,3,2-dioxaphosphorinane group and (b) at least one bromine atom. The component B1 compounds can be represented by structure XI:

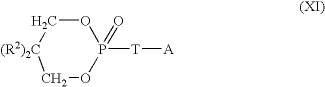

wherein T is as defined before, and A represents an alkane or cycloalkane group that is substituted with at least one bromine atom and is bonded to the -T- linkage through a carbon atom on the A group. The A group in structures XI-XIII may contain from 1 to 50, preferably from 2 to 10 and even more preferably from 3 to 6 carbon atoms. The A group preferably contains at least two bromine atoms. There are preferably no bromine atoms on the carbon atom(s) which are bonded directly to a -T- linkage. The A group may be substituted with one or more additional moieties of the structure:

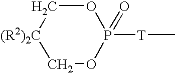

In structure XI, each R² may be independently hydrogen, or an unsubstituted or inertly substituted (but not halogenated) alkyl. In certain embodiments, each R² is a methyl group.

Alternatively, the two R² groups on structure XI may together form a —[C(R³)₂]ₓ— structure wherein each R³ is hydrogen or C₁₋₄ alkyl and x is from 4 to 5. Certain component B1 compounds of this type are represented by structure XII:

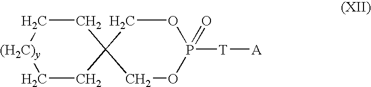

where A and T are as before, and y is 0 or 1.

The two R² groups on structure XI may together form a —CH₂—O—P(O)—O—CH₂— structure that is bonded through the phosphorus atom to another -T-A moiety. Certain component B1 compounds of this type are represented by structure XIII:

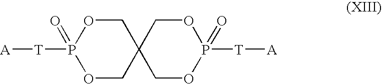

where A and T are as defined before.

Suitable component B1 materials include those that have one or more of the structures XIV-XVI:

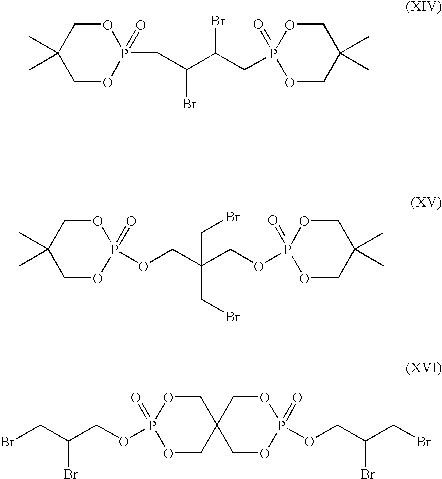

Surprisingly, the component B and B1 compounds usually have excellent thermal stability, as determined by a 5% weight loss temperature analysis. The 5% weight loss temperature is measured by thermogravimetric analysis as follows: ˜10 milligrams of the subject compound are analyzed using a TA Instruments model Hi-Res TGA 2950 or equivalent device, with a 60 milliliters per minute (mL/min) flow of gaseous nitrogen and a heating rate of 10° C./min over a range of from room temperature (nominally 25° C.) to 600° C. The mass lost by the sample is monitored during the heating step, and the temperature at which the sample has lost 5% of its initial weight is designated the 5% weight loss temperature (5% WLT). This method provides a temperature at which a sample has undergone a cumulative weight loss of 5 wt %, based on initial sample weight. The component B or B1 compound preferably exhibits a 5% WLT of at least the temperature at which a styrene homopolymer or copolymer is melt-processed, either to blend the polymer with the component B or B1 compound or to process the blend into extruded foam. The 5% WLT of the component B or B1 compound is often in excess of 200° C., preferably in excess of 220° C. and even more preferably in excess of 240° C.

The component B and B1 additives in most cases can be prepared straightforwardly using simple chemistry. 2-Oxo-1,3,2-dioxophosphorinane starting materials are readily prepared by contacting a dialcohol with POCl₃. If the alcohol has the structure HO—CH₂—C(R²)₂—CH₂—OH, a chlorophosphate compound suitable for preparing component B1 additives is formed, as follows:

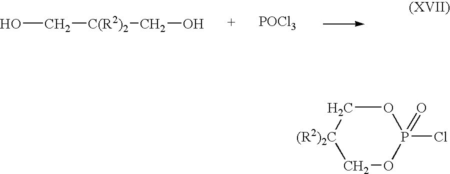

wherein R2 is as defined with regard to structure XI. A starting material for preparing compounds of structure XIII is formed in the reaction of two moles of POCl₃ with pentaerythritol, as follows

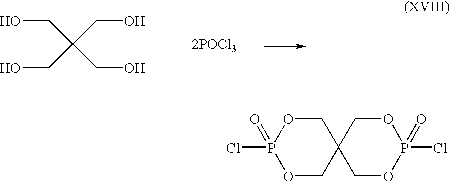

A starting material for preparing component B1 compounds is prepared from 2,2-bis(bromomethyl)-1,3-propanediol and POCl₃, as follows:

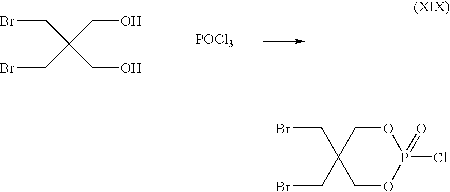

The reactions illustrated in reaction schemes XVII-XIX can be performed by forming a slurry or dispersion of the alcohol in an inert solvent such as toluene, and adding the POCl₃. Suitable temperatures for conducting this reaction are from 20 to 120° C. The reaction is continued until HCl is no longer evolved. The product then can be recovered from the inert solvent in any convenient manner.

Component B compounds of structure II wherein each T is —O— can be formed in a reaction of a chlorophosphate compound produced in reaction scheme XIX with an alcohol of the form R—(OH)ₙ, where R and n are as defined with respect to structure II. Thus, for example, the component B1 compounds shown in structures IV, VI, IX, and X can be prepared by reaction of the chlorophosphate compound formed in reaction scheme XIX with phenol, 1,3-dihydroxybenzene, 2,2,2-tris(bromomethyl)-1-ethanol and 2,2-bis(bromomethyl)1,3-propanediol, respectively.

Component B1 compounds of structures XI, XII or XIII can be prepared in an analogous manner from the chlorophosphate compounds produced in reaction scheme XVII or XVIII, by reaction with a brominated alcohol or polyalcohol. Thus, for example, a component B1 material having structure XV can be prepared in the reaction of the chlorophosphate compound formed in reaction scheme XVII with 2,2-bis(bromomethyl)-1,3-propanediol. Similarly, a component B1 material according to structure XVI can be made from 2 moles of 2,3-dibromo-1-propanol and one mole of the chlorophosphate produced in reaction scheme XVIII.

An alternative method for making certain component B or B1 compounds is to react the starting phosphate compound with an alkene that has allyl hydroxyl groups to form an unsaturated intermediate, followed by brominating the carbon-carbon double bond of the alkenyl group. Thus, for example, a component B1 material according to structure XVI can be prepared via reaction scheme XX, as follows:

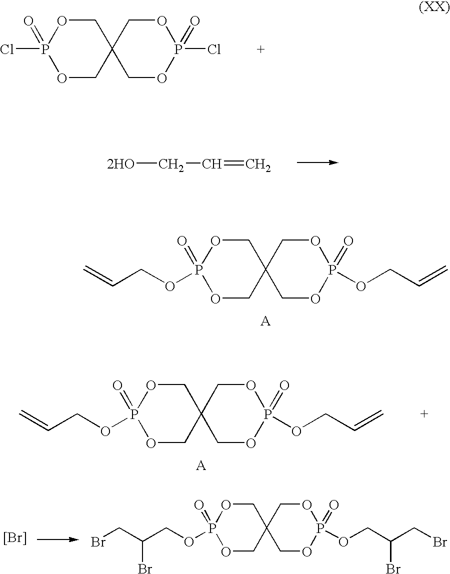

where [Br] represents a bromine source. In reaction scheme XX, bromine can be provided by any convenient bromine source, such as elemental bromine or pyridinium tribromide.

Component B compounds of structure II wherein each T is —NR¹— can be formed in a reaction of a chlorophosphate compound produced in reaction scheme XIX with a primary or secondary amine of the form R—(NR¹H)ₙ, where R, R¹ and n are as defined with respect to structure II. Thus, for example, the component B compounds shown in structures V and VIII can be prepared by reaction of the chlorophosphate compound formed in reaction scheme XIX with aniline and ethylene diamine, respectively.

Component B or B1 compounds of structure II or XII wherein each T is a covalent bond can be formed in two steps from a chlorophosphite compound produced in any of reaction schemes XXI-XXII.

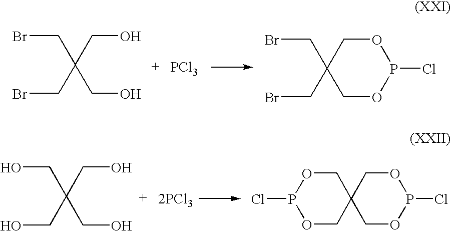

The chlorine atom of the chlorophosphite compound formed in any of reaction schemes XXI-XXII is replaced with an alkoxy group by reaction with an monoalcohol. The alcohol is preferably a secondary alcohol like isopropanol or a tertiary alcohol like t-butanol. The resulting intermediate can then be reacted with a halide of the form R—(X)ₙ or A-(X)ₙ, where R, A and n are as defined with respect to structure II, XI and XII, and X is halogen, preferably chlorine or bromine.

An alternative route to forming certain B1 compounds in which T is a covalent bond is to first replace the chlorine atom of the chlorophosphite compound with an alkoxy group as just described, and then react the resulting intermediate with a halogenated alkene. The alkene group can then be brominated to form the B1 compound. Thus, for example, a component B1 compound according to structure XIV can be prepared according to reaction scheme XXIII:

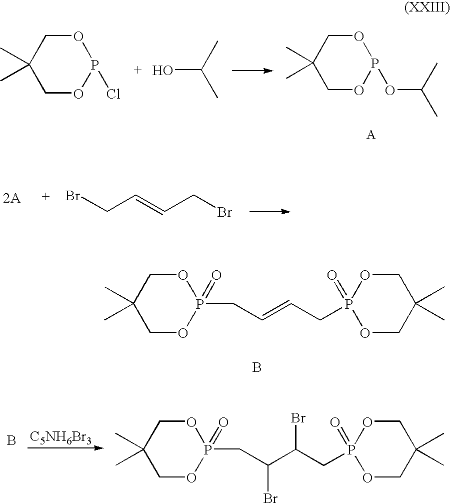

The component B or B1 material is useful as a flame retardant additive in making extruded styrene homopolymer or copolymer foams. A styrene copolymer should contain at least 50 mole percent of repeating styrene units. Suitable styrene copolymers include styrene-acrylic acid copolymers, styrene-acrylonitrile (SAN) copolymers and styrene-acrylonitrile-butadiene (ABS) resins.

The expanded polymer foam of the invention is made in an extrusion process. In the extrusion process, a molten mixture containing the styrene polymer(s), the component B or B1 material, blowing agent(s) and optionally other materials is formed under sufficient pressure to keep the molten mixture from expanding. The component B or B1 material can be introduced into the molten mixture by pre-blending it with the styrene polymer(s) prior to melting the polymer(s), separately forming a concentrated “masterbatch” of the component B or B1 material and a portion of the styrene polymer(s) and mixing that masterbatch with the remainder of the polymer(s) before or after melting them, or by introducing the component B or B1 additive as a liquid, solid or molten solid into the melted polymer. In the process, the molten mixture containing the styrene polymer and the component B or B1 material commonly is brought to a temperature of at least 180° C., often at least 190° C. or at least 200° C. before the molten mixture is extruded. Typically, this occurs at a point in the extrusion process where the styrene polymer is being mixed with other materials, such as the blowing agent and/or the component B or B1 material. Typically (but not necessarily), the molten mixture is subsequently cooled somewhat to a suitable extrusion temperature, and it then passed through a die to a region of lower pressure, such that the mixture simultaneously cools and expands to form a cellular, expanded polymer.

The expanded polymer may be open-celled, closed-celled, or contain both open and closed cells. The preferred extruded, expanded polymer contains at least 70% closed cells. The expanded polymer may be a sheet material having a thickness of not more than ¼ inch (6 mm), or may be a plank material having a thickness of from ¼ inch to 12 inches (0.6 to 30 cm), preferably from 0.5 to 8 inches (1.2 to 20 cm).

A blowing agent is used to provide a gas which generates the cells and expands the molten mixture after it passes through the die. The blowing agent may be a physical (endothermic) or chemical (exothermic) type, or a combination of both. Physical blowing agents include carbon dioxide, nitrogen, air, water, argon, C₂-C₈ hydrocarbons such as the various cyclic and acyclic isomers of butane or pentane, alcohols such as ethanol, and various ethers, esters, ketones, hydrofluorocarbons, chlorofluorocarbons, hydrochlorofluorocarbons and the like. Chemical blowing agents include the so-called “azo” expanding agents, certain hydrazide, semi-carbazide, and nitroso compounds, sodium hydrogen carbonate, sodium carbonate, ammonium hydrogen carbonate and ammonium carbonate, as well as mixtures of one or more of these with citric acid. Another suitable type of expanding agent is encapsulated within a polymeric shell.

The amount of blowing agent that is used is sufficient to impart the desired density to the foam. The extruded polymer foam suitably has a foam density of from about 1 to about 30 pounds per cubic foot (pcf) (16-480 kg/m³), especially from about 1.2 to about 10 pcf (19.2 to 160 kg/m³) and most preferably from about 1.2 to about 4 pcf (19.2 to 64 kg/m³).

Other materials may be present during the extrusion process and in the resulting extruded polymer foam. These include melt flow promoters, other FR agents, including hexabromocyclododecane, other halogenated FR agents, and/or non-halogenated FR agents, other FR synergists, IR attenuators, corrosion inhibitors, colorants, stabilizers, nucleating agents, preservatives, biocides, antioxidants, fillers, reinforcing agents and the like. These and other additives can be used if desired or necessary for the particular extruded foam product or process.

The melt flow promoters are materials that, under fire conditions, help reduce the molecular weight of an organic polymer and thus allow it to melt away from the flame front or other source of heat. The melt flow promoters also are believed to assist in the liberation of HBr from the FR additive under conditions of high temperature, and in that manner increase the effectiveness of the FR additive. Examples of melt flow promoters include 2,3-dimethyl-2,3-diphenylbutane, 2,2′-dimethyl-2,2′-azobutane; bis(alpha-phenylethyl)sulfone; 1,1′-diphenylbicyclohexane; 2,2′-dichloro-2,2′-azobutane, 2,2′-dibromo-2,2′-azobutane, 2,2′-dimethyl-2,2′-azobutane-3,3′,4,4′-tetracarboxylic acid, 1,1′-diphenylbicyclopentane, 2,5-bis(tribromophenyl)-1,3,4-thiadiazole, 2-(bromophenyl-5-tribromophenyl-1,3,4-thiadiazole and poly-1,4-diisopropylbenzene. The presence of from 0.05 to 0.5 parts by weight of a melt flow promoter per 100 parts by weight of the styrene polymer is generally sufficient.

Other FR synergists can be inorganic or organic substances. Inorganic FR synergists include metal oxides (e.g., iron oxide, tin oxide, zinc oxide, aluminum oxide, alumina, antimony (III) oxide and antimony (V) oxide, bismuth oxide, molybdenum (VI) oxide, and tungsten (VI oxide), metal hydroxides (e.g. aluminum hydroxide, magnesium hydroxide), zinc borate, antimony silicates, zinc stannate, zinc hydroxystannate, ferrocene and mixtures thereof. The organic FR synergists include halogenated paraffin, phosphorus compounds and mixtures thereof. The FR synergists may be employed in an amount from 0 to about 6 parts by weight per 100 parts by weight of the polymer.

The component B or B1 material is present in the extruded polymer foam in a flame retarding amount, which is an amount sufficient to improve the performance of the polymer foam in one or more standard fire tests, compared to the performance of an otherwise similar extruded foam that does not contain an FR additive. The amount of the component B or B1 materials is conveniently expressed in terms of the bromine content of the polymer foam. Enough of the component B or B1 material is present to provide the extruded foam with a bromine content of at least 0.5 percent by weight and a phosphorus content of at least 0.1 percent by weight. Preferably, enough of the component B or B1 material is present to provide the extruded foam with from 0.7 to 5 weight percent bromine and from 0.15 to 1.0 weight percent phosphorus. A more preferred level of component B or B1 material provides the extruded foam with a bromine content of from 0.7 to 3.0 weight percent and a phosphorus content of from 0.15 to 0.6 weight percent. The foregoing weight percents are based on the combined weight of the styrene polymer and the component B or B1 material in the extruded foam.

Any one or more of several tests can be used to indicate an improvement in FR performance. Suitable standardized tests include a limiting oxygen index (LOI) measurement in accordance with ASTM D2863; and various time-to-extinguish tests or flame spread tests such as that known as FP-7 (described further below) and the DIN 4102 part 1, NF-P 9215011415, SIA 183 or EN ISO 11925-2 tests which are used in Germany, France, Switzerland and Europe, respectively.

Improvement is established in the LOI method if the limiting oxygen index of the extruded polymer foam is increased by at least 0.5 unit, preferably by at least 1.0 unit and more preferably at least 2 units, compared to an otherwise like foam which does not contain an FR additive. FR performance in the LOI test may be increased by as much as 8 units or more. An extruded styrene polymer or copolymer foam containing the component B or B1 material may exhibit an LOI of at least 21%, preferably at least 22% and more preferably at least 24%. It has been found that the component B and B1 materials can impart very high LOI values to extruded polymer foams, especially extruded polystyrene or styrene copolymer foams, even when used in relatively small amounts. In many cases, the LOI of an extruded polystyrene foam is 24% or higher when the component B or B1 material is present in an amount such that the bromine content of the expanded polymer is from 0.7 to 3.0 weight percent and the phosphorus content is from 0.15 to 0.6 weight percent, based on the combined weight of the styrene polymer and component B or B1 material.

Another fire test is a time-to-extinguish measurement, known as FP-7, which is determined according to the method described by A. R. Ingram, J. Appl. Poly. Sci. 1964, 8, 2485-2495. This test measures the time required for flames to become extinguished when a polymer sample is exposed to an igniting flame under specified conditions, and the ignition source is then removed. An improvement in performance in this test is indicated by a shorter time being required for the flames to become extinguished. The time required for extinguishment under this test, when the extruded polymer foam contains the component B or B1 material, is preferably reduced by at least one second, more preferably by at least 3 seconds and even more preferably by at least 5 seconds, compared to when the extruded polymer foam does not contain an FR additive. A time to extinguishment on the FP-7 test is desirably less than 15 seconds, preferably less than 10 seconds and more preferably less than 5 seconds.

Improvement is indicated in other time-to-extinguishment or flame spread tests such as DIN 4102 part 1, NF-P 92/501/4/5, SIA 183 and EN ISO 11925-2 tests by a “pass” rating, or alternatively by a reduction in the flame height, flame extinction time and/or formation of burning droplets, as specified in the individual test methods, compared to a similar foam that does not contain an FR additive.

The component B and B1 materials exhibit good stability during the extrusion process itself. These materials do not liberate bromine or HBr to any significant extent at the normal extrusion temperatures that are used to process extruded polystyrene foam. During the extrusion process, the mixture containing the molten styrene homopolymer or copolymer, the blowing agent and B or B1 compound may be brought to a temperature of at least 180° C., or at least 190° C., or at least 200° C., or at least 220° C. or at least 240° C. Because the B and B1 materials are highly stable, the risks of injury to humans due to exposure to liberated bromine and HBr is minimized. Polymer molecular weight degradation is also minimized because bromine and HBr are not liberated. Damage to equipment is also reduced because these corrosive by-products are minimally generated, if at all, during the extrusion process. This allows processing equipment to be manufactured using relatively inexpensive materials of construction such as carbon steel, rather than specialized, highly corrosion-resistant steels. It is of course within the scope of the invention to incorporate a corrosion inhibitor into the molten mixture if desired to further protect against the possibility of equipment corrosion.

Surprisingly, good stability of the B and B1 components is seen even when the molten mixture contains water or carbon dioxide, which are often present as all or part of a blowing agent package.

In some embodiments of the invention, the extruded foam additionally contains one or more IR attenuators. IR attenuators are materials that block the passage of infrared radiation through the foam, and thus reduce the transfer of heat through the foam. The effect of these materials is usually manifested as a reduced thermal conductivity, compared to an otherwise like foam in which the IR attenuator is not present. IR attenuators are often particular solids such as aluminum oxide, titanium dioxide or, preferably, carbon black or graphite, which are dispersed throughout the polymer matrix. The particle sizes of these materials typically range from 10 nm (nanometer) to 100 microns. IR attenuators are often used in an amount of from about 0.5 to about 8 parts, preferably from 2 to 5 parts, by weight per 100 parts by weight of polymer in the extruded foam.

The following examples are provided to illustrate the invention, but not to limit the scope thereof. All parts and percentages are by weight unless otherwise indicated.

### PREPARATIVE EXAMPLE 1

In a 1 L reactor, 1.0 mol (262.0 g) of 2,2-bis(bromomethyl)-1,3-propanediol is slurried into 400 ml of stirring toluene. The mixture is heated to 60° C. and 1.0 mol (153.2 g) of phosphorus oxychloride is then added dropwise. After the phosphorus oxychloride is added, the temperature is gradually (˜10° C./hr) heated to 100° C. A clear and colorless solution eventually forms. The temperature is maintained at 100° C. until HCl evolution stops (˜4 hours). When the reaction is complete, the reactor contents are transferred to a boiling flask and concentrated on a rotary evaporator to produce a clear oil. The oil slowly crystallizes to form a waxy, white solid. The resulting product is dibromoneopentylglycol chlorophosphate.

The NMR spectra are consistent with the expected product, which has the structure:

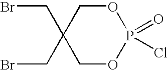

Into a 1 L, 5-neck flask, 91.4 g (0.97 mol) phenol and 102.2 g (1.01 mol) of triethylamine are added to 100 mL of stirring chloroform. The reactor is cooled with an ice bath. To the reaction mixture, a solution of 333.0 g (0.97 mol) of dibromoneopentyl glycol chlorophosphate in 500 mL of chloroform is added dropwise over 1 hour. The ice bath is then removed to allow the reaction temperature to gradually warm up to room temperature. The reaction mixture is then stirred at 50° C. for two hours.

The precipitated solid is isolated through vacuum filtration and washed with aliquots of toluene until all of the color has been removed. The obtained white solid is stirred in 3 L of water for 1 hour, vacuum filtered and dried at 100° C. in a vacuum oven. The yield of the reaction is 76%.

¹H NMR (299.969 MHz, DMSO, vs TMS) d: 7.46 ppm (m, 2H), 7.31 (m, 3H), 4.65 (m, 2H), 4.39 (dd, 2H), 3.87 (s, 2H), 3.57 (s, 2H)

³¹P NMR (121.429 MHz, DMSO, vs H₃PO₄) d −12.6 ppm

The NMR spectra are consistent with the expected product, which has the structure:

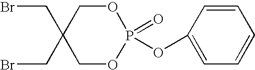

The product has a 5% WLT temperature of 250° C.

### PREPARATIVE EXAMPLE 2

Into a 2 L flask, 90.5 g (0.97 mol) of aniline and 79.1 g (1.0 mol) pyridine are added to 300 mL of stirring acetonitrile. A solution of 333.1 g (0.97 mol) of dibromoneopentylglycol chlorophosphate in 250 mL of acetonitrile is then added dropwise to the reaction mixture over a 2 h period. Additional 200 mL of acetonitrile is added to facilitate stirring of the thick reaction mixture and stirring is continued for an additional hour.

The white solid product is collected by vacuum filtration and washed with aliquots of acetonitrile until all of the color has been removed. The product is dried in a vacuum oven at 100° C. Yield is 65%.

¹H NMR (299.969 MHz, DMSO, vs TMS) d: 8.30 ppm (d, 1H), 7.25 (m, 2H), 7.06 (m, 2H), 6.95 (m, 1H), 4.37 (s, 2H), 4.33 (s, 2H), 3.75 (s, 2H), 3.66 (s, 2H)

³¹P NMR (121.429 MHz, DMSO, vs H₃PO₄) d −1.13 ppm.

The NMR spectra are consistent with the expected product, which has the structure:

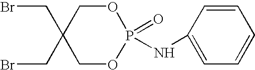

The 5% WLT of this product is 265° C.

### PREPARATIVE EXAMPLE 3

In a 2 L reactor, 1.32 mol (451.8 g) of dibromoneopentyl glycol chlorophosphate and 0.66 mol (72.7 g) of resorcinol are dissolved in 650 mL of acetonitrile. 1.98 mol (200.0 g) of triethylamine is diluted with 50 mL of acetonitrile and loaded into an addition funnel. The triethylamine is added dropwise to the reactor, using an ice bath along with the addition rate to control the reaction temperature below 30° C. Solids precipitate as the addition progresses. A thick, white slurry is formed, which is stirred until no more heat evolves.

The reaction mixture is then stirred into an equal volume of deionized water for 1 hour. The water is then decanted, and the solids are washed again in the same manner using a 1% aqueous HCl solution. The white solids are collected by vacuum filtration and washed on the filter with aliquots of deioinized water, a 1% aqueous HCl solution, deionized water again, acetonitrile, and diethyl ether. The product is dried in a 100° C. vacuum oven. The identity of the desired product is confirmed by NMR and TGA. Proton and ³¹P NMR spectra show the following features:

¹H NMR (299.985 MHz, DMSO, vs TMS): 7.55-7.24 (m, 4H), 4.67 (d, 4H, J=11.7 Hz), 4.39 (m, 4H), 3.86 (s, 4H,), 3.55 (s, 4H). ³¹P NMR (121.436 MHz, DMSO, vs H₃PO₄): −12.87.

The NMR spectra are consistent with the expected product, which has the structure:

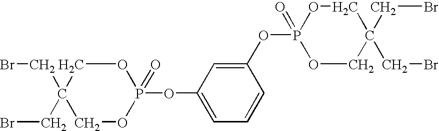

The product has a 5% WLT temperature of 322° C.

### PREPARATIVE EXAMPLE 4

In a 2-L reactor, 1.3 mol (451.7 g) of dibromoneopentyl glycol chlorophosphate are dissolved into 480 mL of acetonitrile. Separately, 0.66 mol (39.6 g) of ethylenediamine and 2.0 mol (202.0 g) of triethylamine are dissolved in 180 mL of acetonitrile and loaded into an addition funnel. Using the addition rate along with an ice bath to control the temperature below 30° C., the amine solution is added dropwise to the reactor. Solids precipitate as the addition progresses. Stirring is continued until no more heat is evolved. The white solids are allowed to settle from the supernatant liquid, and are separated by decanting the liquid.

1 L of 1% aqueous HCl is added to the white solid and the resulting white slurry is stirred vigorously for 1 hour. The white solids are collected by vacuum filtration and then washed on the filter with 500 mL of deionized. water, 500 mL of a 1% aqueous HCl solution, another 500 mL of deioinized water, 250 mL of acetonitrile and 250 mL of diethyl ether. The product is dried in a 100° C. vacuum oven. Proton and ³¹P NMR spectra show the following features:

¹H NMR (299.985 MHz, DMSO, vs TMS): 5.52 (t, 2H, J=6.0 Hz), 4.39 (m, 4H), 4.15 (m, 4H), 3.77 (d, 4H, J=3.9 Hz), 3.59 (d, 4H, J=4.2 Hz), 2.85 (s, 4H).

³¹P NMR (121.436 MHz, DMSO, vs H₃PO₄) 7.33.

The NMR spectra are consistent with the expected product, which has the structure:

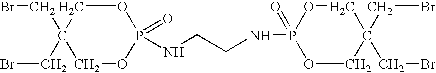

The 5% WLT of this product is 263° C.

### PREPARATIVE EXAMPLE 5

A mixture of (neopentyl)isopropylphosphite (27.097 g, 140.99 mmol) and 1,4-dibromo-2-butene (15.079 g, 70.50 mmol) is formed in a Schlenk flask equipped with a distillation head which has a jacketed Vigreux column and a thermometer. The system is evacuated, placed under nitrogen and heated in a wax bath to 170° C. for 1 hour, during which time 2-bromopropane distills off and the liquid reaction mixture solidifies to a white solid. Xylene (40 mL) is added to the reaction mixture and heating is continued for 3 more hours. The cooled reaction mixture is filtered, washed with toluene, washed with hexane and dried for 2 days in a 55° C. oven. The yield is 14.114 g, 56.83%. Proton, ¹³C and ³¹P NMR spectra show the following features:

¹H NMR (299.985 MHz, C₆D₆, vs TMS): 5.69 (m, 2H), 4.20 (d of d, 4H, J=11.1 Hz, J=8.2 Hz), 3.84 (d of d, 4H, J=13.9 Hz, J=11.2 Hz), 2.73 (d of d of d, 4H, J=17.6 Hz, J=4.2 Hz, J=1.7 Hz), 1.11 (s, 6H), 1.02 (s, 6H). ¹³C NMR (75.438 MHz, C₆D₆, vs CDCl₃) δ: 124.02 (d of d, J=2.0 Hz, J=1.3 Hz), 75.04 (t, J=3.0 Hz), 32.50 (t, J=2.7 Hz), 29.08 (d of d, J=139.5 Hz, J=4.0 Hz), 21.49, 21.29. ³¹P NMR (121.436 MHz, CDCl₃, vs H₃PO₄): 23.27.

The NMR spectra are consistent with the expected product, bis(neopentyl)-1,4-but-2-enylene-diphosphonate, i.e.,

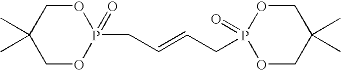

Pyridinium tribromide (0.975 g, 3.05 mmol) slurried in 80 mL of methylene chloride is added dropwise to a 0° C. (ice bath) solution of bis(neopentyl) 1,4-but-2-enylene diphosphonate (1.000 g, 2.84 mmol) in 50 mL of methylene chloride. The reaction mixture is allowed to warm to room temperature and stirred overnight. The resulting pale yellow solution is washed with aqueous Na₂S₂O₃, dried over anhydrous MgSO₄ and filtered. The volatiles are removed under reduced pressure to give a white product with very low solubility in methylene chloride. NMR spectra (H, ¹³C, ³¹P) show 20% product and 80% unreacted starting material. Therefore, the reaction product mixture is slurried in 200 mL of methylene chloride and additional pyridinium tribromide (1.09 g, 3.41 mmol) is added. The flask is allowed to stir at room temperature for several days. The precipitate is filtered out and washed with methylene chloride. Yield of white powder is 1.2165 g, 83.7%. Proton, ¹³C and ³¹P NMR of the product show the following features:

¹H NMR (299.985 MHz, CDCl₃, vs TMS): 4.63 (m, 2H, J=8.3 Hz, 3.9 and others), 4.21 (d of d, 4H, J=9.8 Hz, J=11.1 Hz, J=9.6 Hz), 3.91 (d of d, 4H, J=13.2 Hz, J=10.5 Hz), 2.88 (d of d of d, 2H, J=20.0 Hz, J=16.2 Hz, J=3.91), 2.62 (d of d of d, 2H, J=17.3 Hz, 16.1 Hz, J=8.5 Hz), 1.13 (s, 6H), 1.06 (s, 6H).

¹³C NMR (75.438 MHz, CDCl₃, vs CDCl₃): 76.30, 75.52 (t, J=12.7 Hz), 49.22 (d, J=12.1 Hz), 32.63 (d, J=140.2 Hz), 32.61 (d, J=6.0 Hz), 29.70, 21.69, 21.46.

³¹P NMR (121.436 MHz, CDCl₃, vs H₃PO₄): 23.27.

The NMR spectra are consistent with the expected product, bis(neopentyl)-2,3-dibromo-1,4-butylene-diphosphonate, which has the structure:

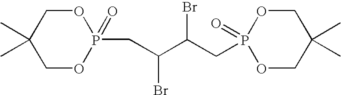

The 5% WLT of this product is 226° C.

### EXAMPLES 1-5 AND COMPARATIVE SAMPLES C1-C3

The following general method is used to produce extruded polystyrene foam Examples 1A-1D, 2A-2E, 3A-3D, 4A-4D and 5A and 5B. Foam Examples 1-5 contain the products of Preparative Examples 1-5, respectively.

A concentrate of 10 wt %, based on concentrate weight, of the Preparative Example in polystyrene is prepared by blending the respective Preparative Example, polystyrene and 2 weight percent, based on the weight of the concentrate, of an organotin carboxylate stabilizer. The blend is melt compounded with the polystyrene using a Haake RHEOCORD™ 90 conical twin screw extruder equipped with a stranding die. The extruder has three temperature zones operating at set point temperatures of 135° C., 170° C. and 180° C. and a die set point temperature of 180° C. The extruded strands are cooled in a water bath and cut into pellets approximately 5 mm in length.

The pellets are converted into a foam using, in sequence, a 25 mm single screw extruder with three heating zones, a foaming agent mixing section, a cooler section and an adjustable 1.5 mm adjustable slit die. The three heating zones operate at set point temperatures of 115° C., 150° C. and 180° C. and the mixing zone operates at a set point temperature of 200° C. Carbon dioxide (4.5 parts by weight (pbw) per 100 pbw combined weight of the concentrate pellets and the additional polystyrene pellets) is fed into the foaming agent mixing section using two different RUSKA™ (Chandler Engineering Co.) syringe pumps. Concentrate pellets and pellets of additional polystyrene are dry blended together with 0.05 wt %, based on dry blend weight, of barium stearate as a screw lubricant. The ratio of the concentrate pellets and pellets of additional polystyrene are selected to provide a final concentration of FR additive as indicated below. The dry blend is added to the extruder's feed hopper and fed at a rate of 2.3 kg/hr. Pressure in the mixing section is maintained above 1500 psi (10.4 MPa) to provide a polymer gel having uniform mixing and promote formation of a foam with a uniform cross-section. The coolers lower the foamable gel temperature to 120° C. to 130° C. The die opening is adjusted to maintain a die back pressure of at least 1000 psi (6.9 MPa). The foamable gel expands as it exits the die to form a polystyrene foam.

In Examples 1B, 2B, 3B and 4B, 0.5 parts of poly-1,4-diisopropylbenzene are added to the molten mixture per 100 parts by weight of the resin. In Examples 1D, 2D, 3D and 4D, 0.55 parts of water are present per 100 parts by weight of the resin, as an additional blowing agent.

Comparative Sample C1 is made in the same general manner as just described, but using no FR additive and 0.55 parts of water per 100 parts by weight of the resin. Comparative Samples C2 and C3 also are made in the same general manner as Example 1, but using hexabromocyclododecane (HBCD) as the FR additive.

Each foam sample is evaluated for density per ASTM D3575-03, Suffix W, Method A. Limiting oxygen index is measured according to ASTM D2863, modified in that the foam sample is a foam rod having a circumference of 5 mm and length of 150 mm. FP-7 testing is performed as described by Ingram, J. Appl. Polym. Sci., 8 (1964) 2485-83. Results are as indicated in Table 1 below.

TABLE I

| Example or | | | | Properties | | |
|---|---|---|---|---|---|---|
| Comparative | FR Additive | | | Density, | LOI, | FP-7 time to |
| Sample | %¹ | % Br² | % P³ | kg/m³ | % | extinguishment, s |
| C1*⁴ | None | 0 | 0 | 34.3 | 20 | >20 |
| C2* | 1.1 | 0.8 | 0 | 36.4 | 25 | 4.8 |
| C3* | 2.5 | 1.9 | 0 | 35.6 | 30.5 | 0.0 |
| 1A | 2.5 | 1.0 | 0.2 | 38.1 | 23.0 | 5.2 |
| 1B⁵ | 2.5 | 1.0 | 0.2 | 38.0 | 25.5 | 4.5 |
| 1C | 5 | 2.0 | 0.4 | 37.3 | 25.5 | 2.4 |
| 1D⁴ | 2.5 | 1.0 | 0.2 | 33.5 | 24 | 6.5 |
| 2A | 2.5 | 1.0 | 0.2 | 41.5 | 21.5 | 11.7 |
| 2B⁵ | 2.5 | 1.0 | 0.2 | 46.3 | 24.0 | 3.2 |
| 2C | 5 | 2.0 | 0.4 | 43.9 | 24.5 | 4.5 |
| 2D⁴ | 2.5 | 1.0 | 0.2 | 34.3 | 25 | 8.5 |
| 2E | 7.5 | 3.0 | 0.6 | 60.4 | 25 | 3.4 |
| 3A | 2.5 | 1.1 | 0.2 | 42.1 | 24.5 | 3.0 |
| 3B⁵ | 2.5 | 1.1 | 0.2 | 37.3 | 24.8 | 0.8 |
| 3C | 5 | 2.2 | 0.4 | 42.1 | 25.7 | 0.6 |
| 3D⁴ | 2.5 | 1.1 | 0.2 | 40.5 | 25.7 | 1.5 |
| 4A | 2.5 | 1.2 | 0.23 | 43.7 | 23.8 | 1.6 |
| 4B⁵ | 2.5 | 1.2 | 0.23 | 38.9 | 26.0 | 1.2 |
| 4C | 5 | 2.4 | 0.48 | 43.7 | 23.8 | 1.6 |
| 4D⁴ | 2.5 | 1.2 | 0.23 | 40.5 | 24.7 | 1.1 |
| 5A | 2.5 | 0.8 | 0.3 | ND | 27.0 | 2.1 |
| 5B | 5 | 1.6 | 0.6 | ND | 26.0 | 0.7 |

*Not an example of this invention.
ND means “not determined”.
¹Loading of indicated FR additive, based on combined weight of polystyrene, FR additive and organotin carboxylate stabilizer compound.
²Wt % bromine in the extruded foam.
³Wt. % phosphorus in the extruded foam.
⁴Samples made using 0.55 pphr of water as additional blowing agent.
⁵Samples made using 0.5 pphr polycumyl as a melt flow promoter.

What is claimed is:

1. A process comprising forming a pressurized mixture of (A) a molten styrene homopolymer or copolymer, a flame retarding amount of (B) or (B1) or a mixture of (B) and (B1), wherein (B) is at least one 5,5-bis(bromomethyl)-2-oxo-1,3,2-dioxaphosphorinane compound and (B1) is at least one alkane or cycloalkane that is substituted with (1) at least one 2-oxo-1,3,2-dioxaphosphorinane group and (2) at least one bromine atom, and (C) a blowing agent, and extruding the mixture into a region of reduced pressure such that the mixture expands and cools to form an expanded polymer containing component (B), (B1) or both (B) and (B1).

2. The process of claim 1, wherein wherein the pressurized, molten mixture is brought to a temperature of at least 180° C. prior to extruding the mixture.

3. The process of claim 2, wherein the pressurized, molten mixture is brought to a temperature of at least 190° C. prior to extruding the mixture.

4. The process of claim 3, wherein the pressurized, molten mixture is brought to a temperature of at least 200° C. prior to extruding the mixture.

5. The process of claim 4, wherein the 5,5-bis(bromomethyl)-2-oxo-1,3,2-dioxaphosphorinane compound is present and has the structure: 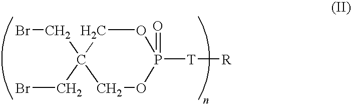
wherein T is a covalent bond, oxygen, sulfur or —NR¹—, wherein R¹ is hydrogen, alkyl or inertly substituted alkyl, n is at least 1, and R is an unsubstituted or inertly substituted organic group that is bonded to the -T- linkage through a carbon atom on the R group.

6. The process of claim 4, wherein the 5,5-bis(bromomethyl)-2-oxo-1,3,2-dioxaphosphorinane compound is present and has any of the structures:

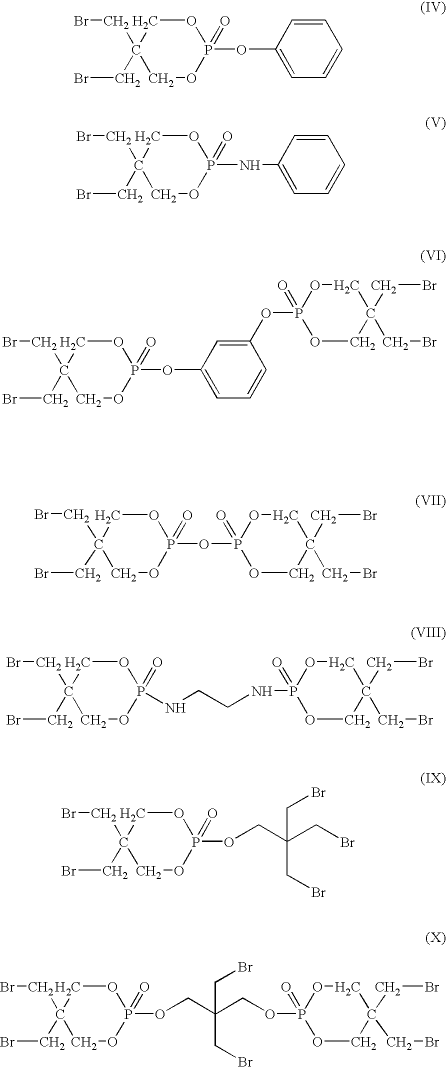

7. The process of claim 4, wherein component B1 is present and has the structure: 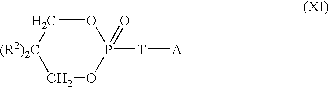
wherein T is a covalent bond, oxygen, sulfur or —NR¹—, and A represents an alkane or cycloalkane group that is substituted with at least one bromine atom and is bonded to the -T- linkage through a carbon atom on the A group.

8. The process of claim 4, wherein component B1 is present and has any of the structures:

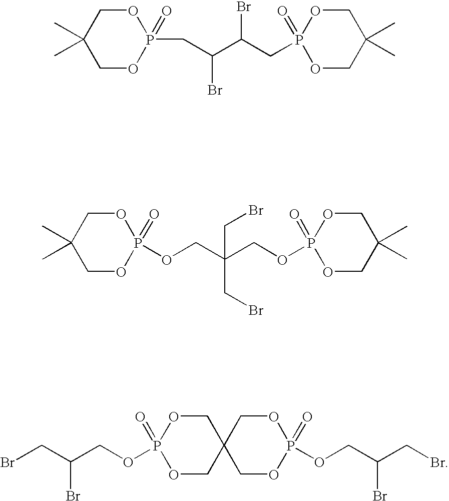

9. The process of claim 4, wherein the pressurized mixture further contains a melt flow promoter.

10. The process of claim 4, wherein the blowing agent includes water, carbon dioxide, or both water and carbon dioxide.

11. An extruded combustible styrene homopolymer or copolymer foam, having a density of from 1 to about 30 lb/ft³ (16-480 kg/m³) and containing at least one 5,5-bis(bromomethyl)-2-oxo-1,3,2-dioxaphosphorinane compound, at least one alkane or cycloalkane that is substituted with at least one 2-oxo-1,3,2-dioxaphosphorinane group and at least one bromine atom, or a mixture thereof.
